(19) United States
(12) Patent Application Publication
(10) Pub. No.: US 2016/0107873 A1
(43) Pub. Date: Apr. 21, 2016

(54) MIXED LIQUID DISPENSING SYSTEM

(71) Applicant: GLOBAL AGRICULTURAL TECHNOLOGY AND ENGINEERING, LLC, Vero Beach, FL (US)

(72) Inventors: Gillian Callaghan, Wellesley, MA (US); Peter Brooke, Micco, FL (US); Michael Cheney, Vero Beach, FL (US); John Newton, Vero Beach, FL (US)

(21) Appl. No.: 14/894,650

(22) PCT Filed: May 27, 2014
(86) PCT No.: PCT/US14/39586

§ 371 Date: Nov. 30, 2015

Related U.S. Application Data
(60) Provisional application No. 61/830,245, filed on Jun. 3, 2013.

(51) Int. Cl. B67D 1/04

(52) U.S. Cl. CPC B67D 1/04

(57) ABSTRACT

A liquid mixing and dispensing system comprises a housing enclosing a chamber containing multiple containers, a flexible bag is in each of the containers. The flexible bags contain first liquids. Connecting conduits lead from the bags to a discharge conduit. A supply conduit is configured and arranged to supply a pressurized second liquid to the containers and to the discharge conduit. The pressurized second liquid serves to collapse the bags and eject the first liquids from the bags and via the connecting conduits into the discharge conduit for mixture with the first liquid.

### PRIORITY

The present application claims priority to U.S. Provisional Application Ser. No. 61/830,245 filed on Jun. 3, 2013, which is hereby incorporated by reference in its entirety.

### BACKGROUND

1. Field

Embodiments of the present invention relate generally to liquid mixing and dispensing systems, and are concerned in particular with packaged systems that may be portable and/or disposable.

2. Description of Related Art

In a known liquid mixing and dispensing system disclosed in U.S. Pat. No. 7,451,895, flexible bags containing liquid concentrates are enclosed in a container closed by a cap. A manifold in the cap has metered inlet orifices communicating with the flexible bags and with the container interior. Pressurized liquid, e.g. a water diluent, is admitted into the container. The water collapses the bags causing the liquid concentrates to be ejected into the manifold. Water enters the manifold from the container and combines with the liquid concentrates to provide a liquid mixture delivered from a manifold outlet.

When mixing and dispensing liquid components of a beverage, and because the water diluent enters the manifold from the container, the entire container interior must first be sterilized and then kept free of contaminants during assembly of the system components. Sterilization contributes disadvantageously to the overall cost of the system, and contaminant free assembly is difficult to achieve reliably.

### SUMMARY

Broadly stated, embodiments of the present invention address the above described problem, while additionally providing other advantages not offered by known systems.

### BRIEF DESCRIPTION OF THE DRAWINGS

FIG. 1 is a diagrammatic illustration of a liquid mixing and dispensing system in accordance with an exemplary embodiment of the present invention; and

FIG. 2 is a diagrammatic illustration of an alternative embodiment of a liquid mixing and delivery system in accordance with an exemplary embodiment of the present invention.

### DETAILED DESCRIPTION

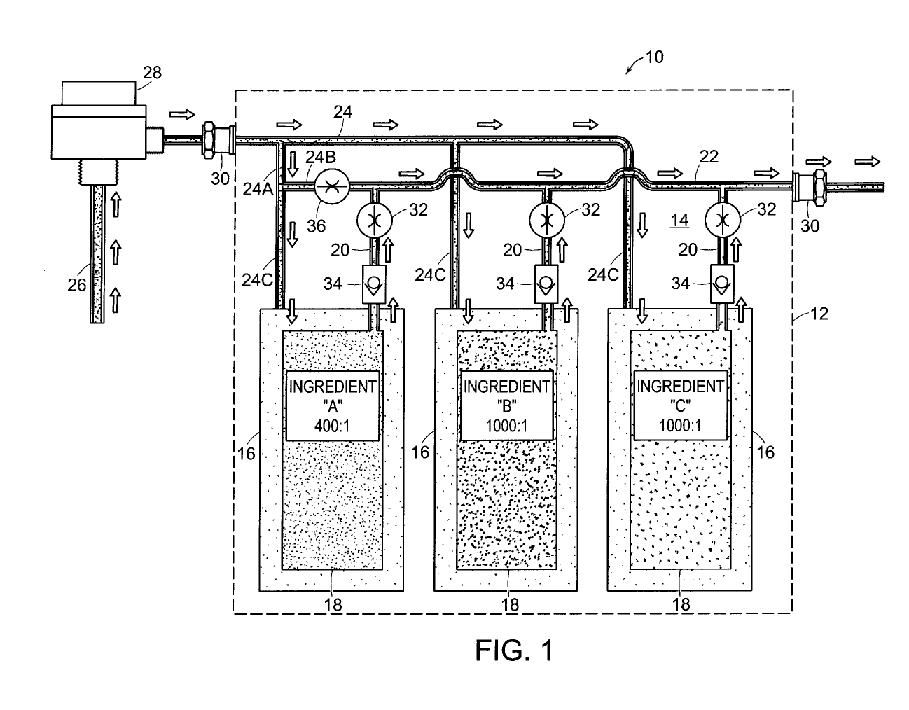

With reference initially to FIG. 1, a liquid mixing and dispensing system is shown at 10. The system comprises a housing 12 enclosing a chamber 14. Multiple containers 16 are arranged in the chamber. Flexible sealed bags 18 are in each of the containers. The bags contain first liquids to be dispensed via connecting conduits 20 to a discharge conduit 22. A supply conduit 24 is configured and arranged to supply a pressurized second liquid to the discharge conduit 22 via branch conduits 24a, 24b, and to the containers 16 via branch conduits 24c. The pressurized second liquid serves to collapse the bags 18, causing the first liquids to be ejected via the connecting conduits 20 into the discharge conduit 22 for mixture with the second liquid.

The first liquids may be concentrated components of a beverage, and the second liquid may be a diluent, typically water received via conduit 26 from a variable pressure municipal source.

A constant flow valve 28 may be employed to maintain the pressure of the second liquid being delivered to the discharge conduit 22 and to the containers 18 at a substantially constant level.

As herein employed, the term “constant flow valve” means a flow control valve of the type described, for example, in any one of U.S. Pat. Nos. 7,617,839; 6,026,850 or 6,209,578, the descriptions of which are herein incorporated by reference in their entirety. These types of valves are normally closed, are opened in response to pressures exceeding a lower threshold level, are operative at pressures between the lower threshold level and an upper threshold level to deliver liquids at a substantially constant pressures, and are again closed at pressures above the upper threshold level.

Quick disconnect couplings 30 outside of the housing 12 may provide connections between the supply conduit 24 and the constant flow valve 28, and between the discharge conduit 22 and a remote dispenser or other delivery system (not shown).

Fixed metering orifices 32 and check valves 34 may be provided in the connecting conduits 20, and an additional fixed metering orifice 36 may be provided in the branch line 24b leading to the discharge conduit 22.

The housing 12 may comprise a shipping carton, which may be disposable along with its contents after the first liquids in the bags 18 have been exhausted.

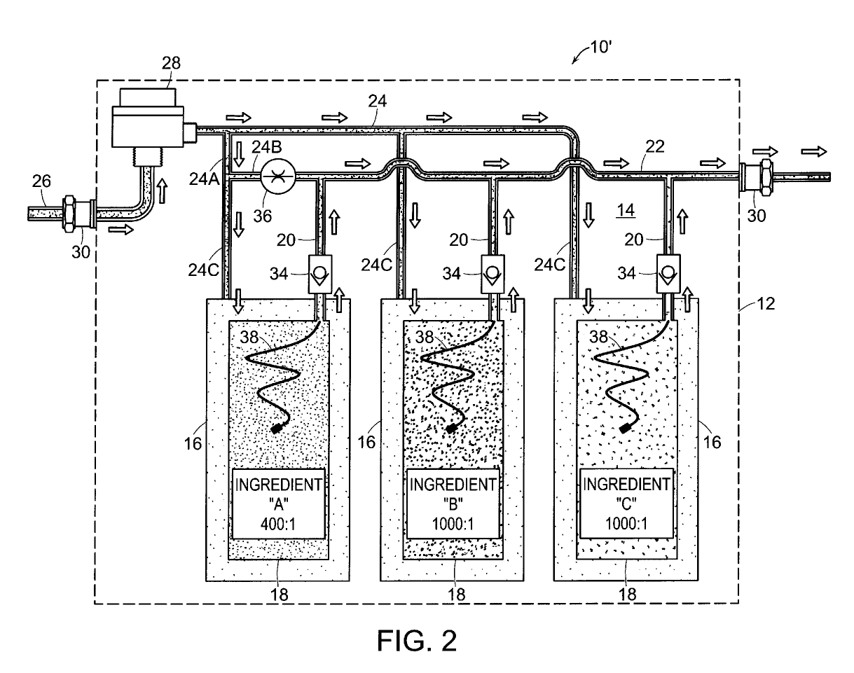

A similar mixing and delivery system is disclosed at 10′ in FIG. 2, with the following differences:
a) the constant flow valve 28 is arranged inside rather than outside of the housing 12; and
b) The fixed metering orifices 32 of FIG. 1 have been replaced by tube orifices 38 in the collapsible bags 18. The lengths and/or internal sizes of the tube orifices 38 provide flow resistances comparable to the metering orifices 32, and are particularly suited for the metering of liquids having high viscosities and/or elevated levels of particulates.

In each of the above described embodiments, the contents of the sealed bags 18 are isolated from the pressurized liquid being fed into the containers 18. Thus, and in particular when the bags contain liquid beverage components, there is no need to sterilize the containers.

What is claimed is:

1. A liquid mixing and dispensing system comprising:
a housing enclosing a chamber;
multiple containers in said chamber;
a flexible bag in each of said containers;
first liquids in said bags;
connecting conduits leading from said bags to a discharge conduit; and
a supply conduit configured and arranged to supply a pressurized second liquid to said containers and to said discharge conduit, said pressurized second liquid serving to collapse said bags and eject said first liquids from said bags and via said connecting conduits into said discharge conduit for mixture with said first liquid.

2. The system of claim 1 wherein the pressure of said second liquid is maintained at a substantially constant level by a constant flow valve.

3. The system of claim 2 wherein said constant flow valve is located exteriorly of said housing.

4. The system of claim 2 wherein said constant flow valve is located in said housing.

5. The system of claim 1 wherein said housing comprises a shipping carton, and wherein said carton and its contents are constructed and arranged for disposal upon exhaustion of said first liquids.

6. The system of claim 1 wherein metering orifices are provided in said connecting conduits.

7. The system of claim 1 or 6 wherein check valves are provided in said connecting conduits.

8. The system of claim 1 wherein a metering orifice is provided between said supply conduit and said discharge conduit.

9. The system of claim 1 wherein said connecting conduits communicate with orifice tubes in said bags.
